(19) United States
(12) Patent Application Publication
(10) Pub. No.: US 2004/0078663 A1
(43) Pub. Date: Apr. 22, 2004

(54) Information processing system and disk control method used in the same

(75) Inventor: Tsutomu Inaba, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/418,284

(22) Filed: Apr. 18, 2003

(30) Foreign Application Priority Data
Jun. 28, 2002 (JP) 2002-190889

(51) Int. Cl. G06F 11/00

(52) U.S. Cl. 714/22

(57) ABSTRACT

An information processing system includes an information processing apparatus and a disk storage device. The information processing apparatus includes a first power supply unit, a unit that generates a first power-failure notice signal, which indicates that power supply from the first power supply unit is to be stopped, before the power supply from the first power supply unit is stopped, and a disk control unit. The disk storage device includes a second power supply unit, and a unit that sends a second power-failure notice signal, which indicates that power supply from the second power supply unit is to be stopped, to the information processing apparatus before the power supply from the second power supply unit is stopped. The disk control unit includes a unit which halts access to the disk storage device upon receiving one of the first and second power-failure notice signals.

### CROSS-REFERENCE TO RELATED APPLICATIONS

This application is based upon and claims the benefit of priority from the prior Japanese Patent Application No. 2002-190889, filed Jun. 28, 2002, the entire contents of which are incorporated herein by reference.

### BACKGROUND OF THE INVENTION

1. Field of the Invention

The present invention relates to an information processing system including an information processing apparatus and a disk storage device, each of which has a power supply unit, and a disk control method used in the information processing system.

2. Description of the Related Art

In these years, RAID (Redundant Array of Inexpensive Disks) technology has widely been used in information processing apparatuses such as server computers, in order to increase access speed and enhance operational reliability of disk storage units. The RAID technology is classified into such types as RAID0, RAID1, RAID10 and RAID5. Of these types, RAIDS is predominant because of its excellent fault tolerance.

In the RAID5 disk array, a plurality of parity groups are provided in association with a plurality of disk drive units that constitute the disk array. Each parity group includes a plurality of data blocks and parity information for use in correcting an error in the data blocks. Even if a fault has occurred in one of the disk drive units, data restoration can be achieved based on the data blocks and parity information stored in the other disk drive units.

In addition, a server computer uses a power supply unit with a power-failure tolerance as means for coping with power supply abnormality such as a power failure or a fault in the power supply unit. This kind of power supply unit can maintain power supply for a predetermined time period even after the occurrence of power failure. Thus, during the predetermined time period, the server computer can perform a necessary data-integrity maintaining process for preventing loss of data, etc.

To be more specific, the server computer immediately halts access to the disk array in response to the occurrence of power supply abnormality, thereby preventing loss of unsaved write data that has not yet been written in the disk array.

However, in a system configuration that has recently been put to practical use, a disk array is accommodated not in the main body of the server computer, but in an external extension device, aiming at reducing the size of the server computer. In this case, a power supply unit is independently provided in each of the server computer and the external extension device.

If power supply abnormality has occurred only in the power supply unit in the external extension device, the server computer cannot detect the occurrence of the power supply abnormality. This makes it impossible to halt the access to the disk array before the operation of the disk array is stopped. Consequently, unsaved write data would be lost. Furthermore, in the absence of a response from any of the disk drive units of the disk array, the server computer erroneously recognizes that all the disk drive units have failed. The fault information of each disk drive unit based on the erroneous recognition is kept in the server computer unless and until disk exchange, for instance, is performed. Hence, even if the external extension device has recovered from a power failure or a power supply fault, the server computer cannot start access to the disk array in the external extension device.

The above-described problem with the maintenance of power supply will also occur, for example, when the power-failure tolerance of the power supply unit in the external extension device is lower than that of the power supply unit in the server computer.

### BRIEF SUMMARY OF THE INVENTION

According to an embodiment of the present invention, there is provided an information processing system including an information processing apparatus and a disk storage device, the system comprising: a first power supply unit provided in the information processing apparatus; a unit that is provided in the information processing apparatus and generates a first power-failure notice signal, which indicates that power supply from the first power supply unit is to be stopped, before the power supply from the first power supply unit is stopped; a second power supply unit provided in the disk storage device; a unit that is provided in the disk storage device and sends a second power-failure notice signal, which indicates that power supply from the second power supply unit is to be stopped, to the information processing apparatus before the power supply from the second power supply unit is stopped; and a disk control unit that is provided in the information processing apparatus and controls the disk storage device, the disk control unit including a unit which halts access to the disk storage device upon receiving one of the first and second power-failure notice signals.

According to another embodiment of the present invention, there is provided an information processing system including an information processing apparatus and a disk storage device, the system comprising: a first power supply unit provided in the information processing apparatus; a unit that is provided in the information processing apparatus and generates a power-failure notice signal, which indicates that power supply from the first power supply unit is to be stopped, before the power supply from the first power supply unit is stopped; a second power supply unit provided in the disk storage device; a unit that is provided in the disk storage device and stores power-failure information indicative of whether power supply from the second power supply unit is stopped; and a disk control unit provided in the information processing apparatus and controlling the disk storage device, the disk control unit including means for accessing the disk storage device, means for halting access to the disk storage device upon receiving the power-failure notice signal, means for detecting whether a fault has occurred in the disk storage device or not, on the basis of presence/absence of a response to the access from the disk storage device, and means for invalidating a detection result indicative of the occurrence of the fault in the disk storage device when the power-failure information is indicative of the stop of the power supply from the second power supply unit.

According to still another embodiment of the present invention, there is provided an information processing system including an information processing apparatus and a disk storage device, the system comprising: a first power supply unit provided in the information processing apparatus and configured to maintain power supply for a predetermined time period from occurrence of a power failure; a unit that is provided in the information processing apparatus and generates a power-failure notice signal, which indicates that power supply from the first power supply unit is to be stopped, before the power supply from the first power supply unit is stopped; a second power supply unit provided in the disk storage device and configured to maintain power supply for a longer time period than the first power supply unit from occurrence of a power failure; and a disk control unit that is provided in the information processing apparatus and controls the disk storage device, the disk control unit including a unit which halts access to the disk storage device upon receiving the power-failure notice signal.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the structure of an information processing system according to a first embodiment of the present invention;

FIG. 2 is a block diagram showing structures of power supply units of a server computer and an extension HDD device provided in the information processing system shown in FIG. 1;

FIG. 3 is a flow chart illustrating a fault detection function of a RAID controller in the server computer provided in the information processing system shown in FIG. 1;

FIG. 4 is a flow chart illustrating a processing procedure that is executed by the RAID controller in the server computer provided in the information processing system shown in FIG. 1 when power supply abnormality has occurred;

FIG. 5 is a block diagram showing another example of the structure of the information processing system according to the first embodiment of the invention;

FIG. 6 is a block diagram showing an example of the structure of an HDD bus interface in the extension HDD device provided in the information processing system shown in FIG. 5;

FIG. 7 is a flow chart illustrating the operation of a RAID controller in the server computer provided in the information processing system shown in FIG. 5;

FIG. 8 is a block diagram showing the structure of an information processing system according to a second embodiment of the present invention;

FIG. 9 is a flow chart illustrating the operation of a RAID controller in the server computer provided in the information processing system shown in FIG. 8;

FIG. 10 is a block diagram showing the structure of an information processing system according to a third embodiment of the present invention; and

FIG. 11 is a block diagram showing structures of power supply units of a server computer and an extension HDD device provided in the information processing system shown in FIG. 10.

### DETAILED DESCRIPTION OF THE INVENTION

Embodiments of the present invention will now be described with reference to the accompanying drawings.

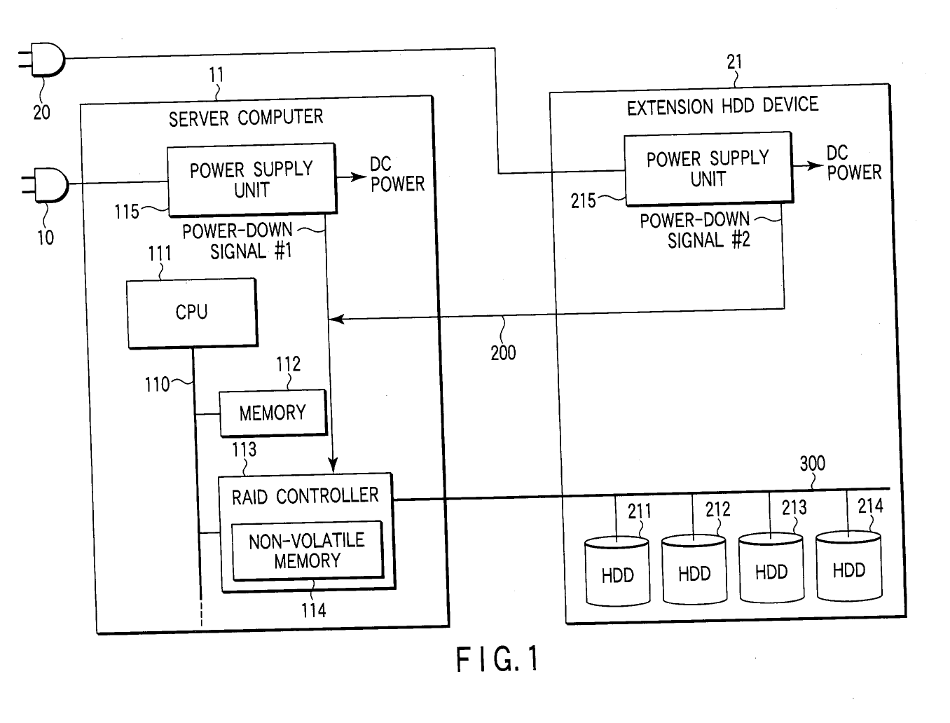

FIG. 1 shows the structure of an information processing system according to a first embodiment of the present invention. The information processing system comprises an information processing apparatus and a disk storage device, which are operated by different power supply units. In the description below, an information processing system comprising a server computer 11 and an extension HDD device 12 will be explained by way of example.

As is shown in FIG. 1, the server computer 11 contains a CPU 111, a memory 112, a RAID (Redundant Array of Inexpensive Disks) controller 113 and a power supply unit 115. The CPU 111, memory 112 and RAID controller 113 are connected to a system bus 110. The CPU 111 is a processor for controlling the operation of the server computer 11. The CPU 112 executes various programs stored in the memory 112.

The RAID controller 113 is a device configured to control a disk storage device. The RAID controller 113 controls a disk array provided in the extension HDD device 12. The disk array comprises a plurality of hard disk drives (HDD) 211 to 214. The RAID controller 113 supports the following types of disk arrays: RAID0, RAID1, RAID10 and RAID5. The RAID controller 113 controls the hard disk drives (HDD) 211 to 214, according to the RAID type designated by a RAID utility program executed by the CPU 111. The RAID controller 113 has a non-volatile memory 114. The non-volatile memory 114 stores the following disk management information for managing the disk array:

Mode information indicative of the RAID type used,

Number of HDDs that constitute the disk array,

Total storage size of the disk array, and

Fault information relating to each HDD of the disk array.

The RAID controller 113 includes the following functions: (1) A fault detection function for detecting a fault in each hard disk drive, (2) a rebuild function for rebuilding the data on the disk array after a failed hard disk drive is replaced with a new drive, and (3) a data-integrity maintaining function for immediately halting access to the disk array, in case of power failure, and preventing loss of unsaved write data.

In the absence of a response from the accessed hard disk drive, the RAID controller 113 determines that the hard disk drive has failed. The drive number of the failed hard disk drive is written in the non-volatile memory 114 as fault information.

The power supply unit 115 receives power from an external AC power supply via an AC plug 10 and generates a DC power supply for supplying power to the components of the server computer 11. The power supply unit 115 has a power-failure tolerance and can maintain a DC power supply for a predetermined time period (e.g. 500 ms) from a time point when the AC power supply is halted by a power failure or a time point when operational abnormality has occurred in the power supply unit 115. In case of a power failure or operational abnormality in the power supply unit 115, the power supply unit 115 generates a first power-down signal. The first power-down signal is a power-failure notice signal indicating that the power supply will shortly be stopped, prior to actual stop of power supply from the power supply unit 115.

The first power-down signal is sent from the power supply unit 115 to the RAID controller 113, thereby causing the RAID controller 113 to execute a data-integrity maintaining process.

The extension HDD device 21 is an extension device for functional extension of the server computer 11. The extension HDD device 21 functions as an external disk storage device that is accessible by the server computer 11. The extension HDD device 21 accommodates a plurality of hard disk drives (HDD) 211 to 214. A disk access bus 300, such as an SCSI (Small Computer System Interface), extends from the server computer 11 to the extension HDD device 21. The RAID controller 113 accesses the hard disk drives (HDD) 211 to 214 via the disk access bus 300.

The extension HDD device 21 incorporates a power supply unit 215 for supplying operational power to the hard disk drives (HDD) 211 to 214.

The power supply unit 215 receives power from an external AC power supply via an AC plug 20 and generates a DC power supply for supplying DC power to the hard disk drives (HDD) 211 to 214. The power supply unit 215 has a power-failure tolerance and can maintain a DC power supply for a predetermined time period (e.g. 500 ms) from a time point when the AC power supply is halted by a power failure or a time point when operational abnormality has occurred in the power supply unit 215. In case of a power failure or operational abnormality in the power supply unit 215, the power supply unit 215 generates a second power-down signal. The second power-down signal is a power-failure notice signal indicating that the power supply will shortly be stopped, prior to actual stop of power supply from the power supply unit 215. The second power-down signal is sent from the extension HDD device 21 to the server computer 11 via a dedicated signal line 200 provided between the server computer 11 and extension HDD device 21.

In the server computer 11, the first power-down signal from the power supply unit 115 and the second power-down signal from the power supply unit 215 of extension HDD device 21 are joined by WIRED-OR connection, and a logical OR signal obtained by a WIRED-OR operation of the first and second power-down signals is input to the RAID controller 113. Thereby, the RAID controller 114 can detect power supply abnormality, such as a power failure or a power supply fault, no matter whether it has occurred in the server computer 11 or in the extension HDD device 21. Therefore, the RAID controller 114 can start a necessary data-integrity maintaining process.

Assume that only the AC power supply of the extension HDD device 21 has failed due to, e.g. disconnection. In this case, the power supply unit 115 does not generate the first power-down signal, but the power supply unit 215 generates the second power-down signal. The second power-down signal is sent from the extension HDD device 21 to the server computer 11. The RAID controller 114 can thus recognize the power supply abnormality. The RAID controller 114 immediately stops the access to the disk array (hard disk drives 211 to 214), thereby preventing loss of unsaved write data or erroneous recognition of all the HDDs as failed disk drives.

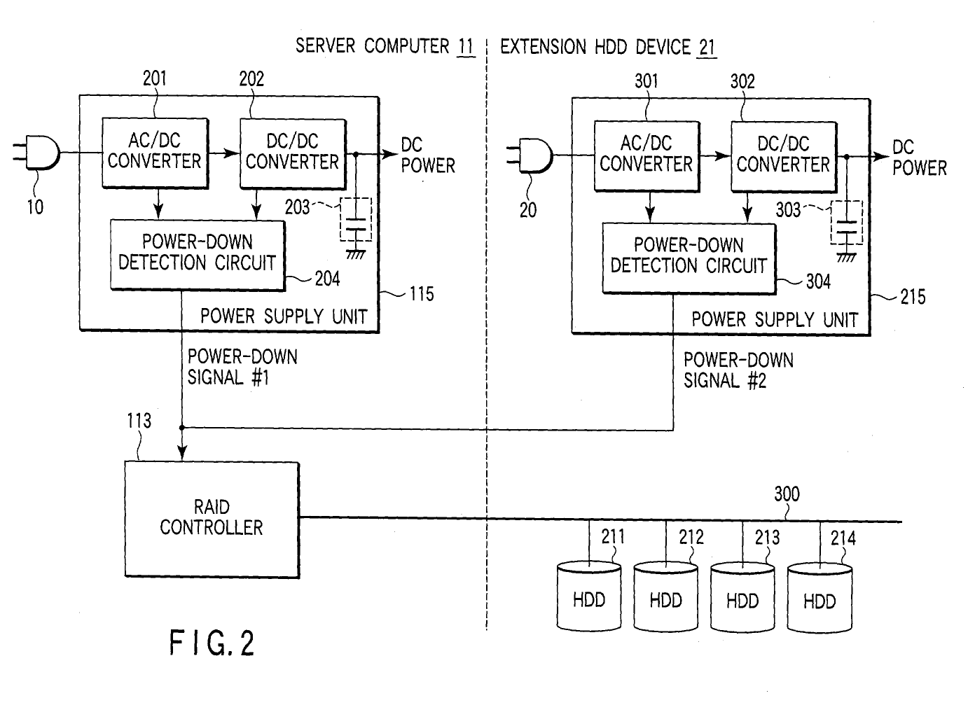

FIG. 2 shows an example of the structures of the power supply units 115 and 215.

The power supply unit 115, as shown in FIG. 2, comprises an AC/DC converter 201, a DC/DC converter 202, a battery 203 and a power-down detection circuit 204. The AC/DC converter 201 converts an AC power supply input via the AC plug 10 to a DC power supply of a relatively high voltage.

The DC/DC converter 202 generates a DC power supply voltage of a predetermined voltage value from the DC power supply obtained from the AC/DC converter 201. The battery 203 comprises, e.g. a large-capacitance capacitor, and it accumulates a DC power supply voltage. By virtue of the function of the battery 203, even when an AC power supply failure or a circuitry fault in the power supply unit 115 has occurred, a DC power supply voltage of a predetermined voltage value can continuously be supplied for a predetermined time period from that time point.

The power-down detection circuit 204 is a circuit for generating the first power-down signal. The power-down detection circuit 204 monitors the operation of the power-supply unit 115. If the power-down detection circuit 204 has detected abnormality, it generates the first power-down signal. The first power-down signal is, e.g. a binary signal. The power-down signal=“0” indicates the normal operation of the power-supply unit 115, and the power-down signal=“1” indicates the occurrence of a power failure or operational abnormality of the power supply unit 115.

The power supply unit 215, like the power supply unit 115, comprises an AC/DC converter 301, a DC/DC converter 302, a battery 303 and a power-down detection circuit 304. The AC/DC converter 301 converts an AC power supply input via the AC plug 20 to a DC power supply of a relatively high voltage. The DC/DC converter 302 generates a DC power supply voltage of a predetermined voltage value from the DC power supply obtained from the AC/DC converter 301. The battery 303 comprises, e.g. a large-capacitance capacitor, and it accumulates a DC power supply voltage. By virtue of the function of the battery 303, even when an AC power supply failure or a circuitry fault in the power supply unit 215 has occurred, a DC power supply voltage of a predetermined voltage value can continuously be supplied for a predetermined time period from that time point.

The power-down detection circuit 304 is a circuit for generating the second power-down signal. The power-down detection circuit 304 monitors the operation of the power-supply unit 215. If the power-down detection circuit 304 has detected abnormality, it generates the second power-down signal. The second power-down signal is also a binary signal. The power-down signal=“0” indicates the normal operation of the power-supply unit 215, and the power-down signal=“1” indicates the occurrence of a power failure or operational abnormality of the power supply unit 215.

It is not necessary that the power-down detection circuits 204 and 304 are provided in the power supply units 115 and 215. Alternatively, the power-down detection circuits 204 and 304 may be provided outside the power supply units 115 and 215.

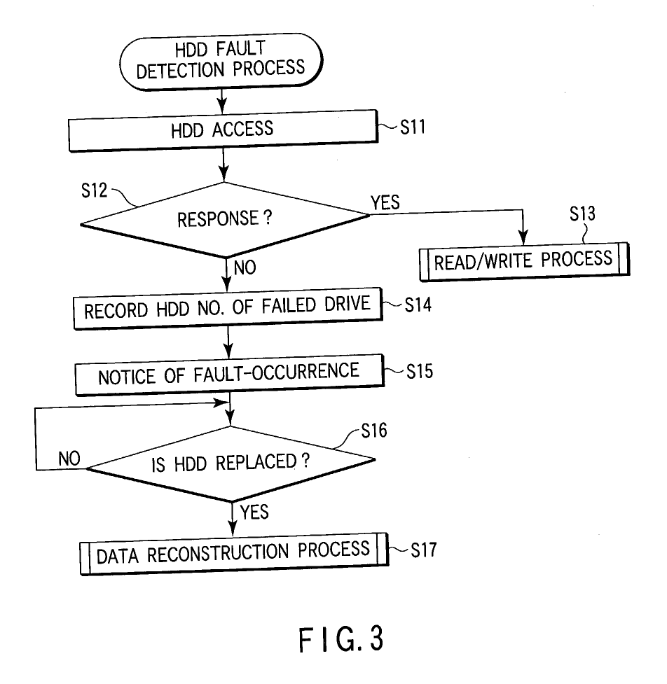

Referring to a flow chart of FIG. 3, the fault detection function of the RAID controller 113 will now be described.

Responding to a read/write request from the CPU 111, the RAID controller 113 accesses each of the HDDs 211 to 214, which constitute the RAID5-type disk array, via the disk access bus 300 (step S1). In the process of accessing the HDDs 211 to 214, the RAID controller 113 monitors the presence/absence of a response from each accessed HDD, thus determining whether the HDD normally functions (step S12). The RAID controller 113 recognizes that the HDD, which has returned a response, is normally operating, and executes a process of data write/read to/from the HDD (step S13).

On the other hand, in the absence of a response from the accessed HDD, the RAID controller 113 determines that the HDD has failed and writes the associated HDD number in the non-volatile memory 114 as fault information (step S14). If necessary, the occurrence of fault is told to the RAID utility program, etc. (step S15). In the RAIDS-type disk array, even where one HDD has failed, the original data can be restored from the other HDDs.

If the failed HDD is replaced with a new HDD (step S16), the RAID controller 113 executes a rebuilding process for data reconstruction under control of the RAID utility program (step S17). Upon completion of the rebuilding process, the fault information in the non-volatile memory 114 is cleared.

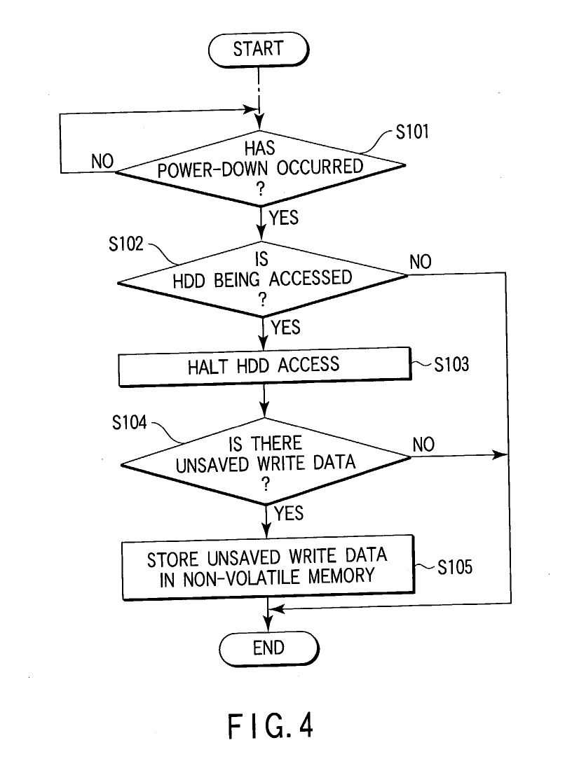

Next, referring to a flow chart of FIG. 4, a description will be given of a process to be executed by the RAID controller 113 when power supply abnormality has occurred.

If any one of the first and second power-down signals has been generated (S101), the RAID controller 113 determines whether disk access to the disk array is being executed (step S102).

If the disk access is being executed, the RAID controller 113 immediately halts the disk access (step S103). The RAID controller 113 determines whether there is unsaved write data that is yet to be written in the disk array (step S104). If there is such unsaved write data, the write data is stored in the non-volatile memory 114 (step S105).

As has been described above, according to the system of this embodiment, the power-down signal is sent from the extension HDD device 21 to the server computer 11. Thus, no matter whether power supply abnormality such as a power failure has occurred in the server computer 11 or in the extension HDD device 21, the disk access by the RAID controller 113 can be halted. Therefore, no matter whether power supply abnormality has occurred in the server computer 11 or extension HDD device 21, it is possible to prevent loss of unsaved write data that is yet to be written in the disk array or the erroneous recognition of all HDDs as failed disk drives.

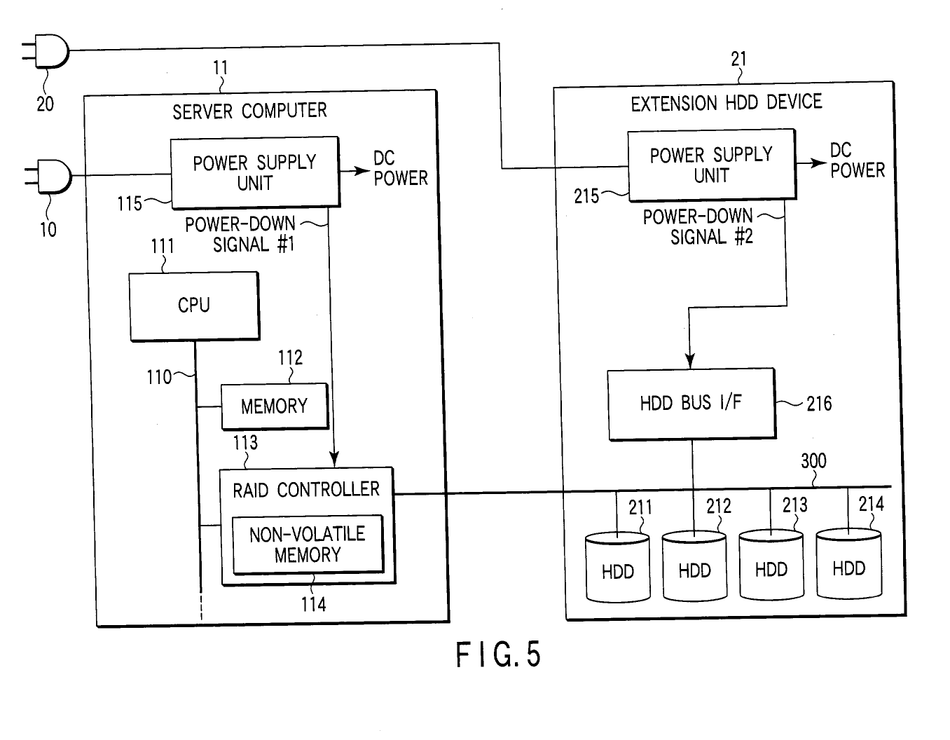

FIG. 5 shows a second example of the extension HDD device 21. In the extension HDD device 21 shown in FIG. 5, the generation of the second power-down signal is told to the RAID controller 113 of server computer 11 through the disk access bus 300, and not through the dedicated signal line.

Specifically, the extension HDD device 21 shown in FIG. 5 is provided with an HDD bus interface unit 216. The HDD bus interface unit 216, like the HDDs 211 to 214, is supplied with DC power from the power supply unit 215. When the power supply unit 215 has generated the second power-down signal, the HDD bus interface unit 216 starts a bus transaction (power-down notice) for sending to the RAID controller 114 the data indicative of the generation of the second power-down signal. Upon receiving the bus transaction, the RAID controller 114 halts the disk access. It is thus possible to prevent loss of unsaved write data, the write operation of which is in progress, or the erroneous recognition of all the HDDs as failed disk drives.

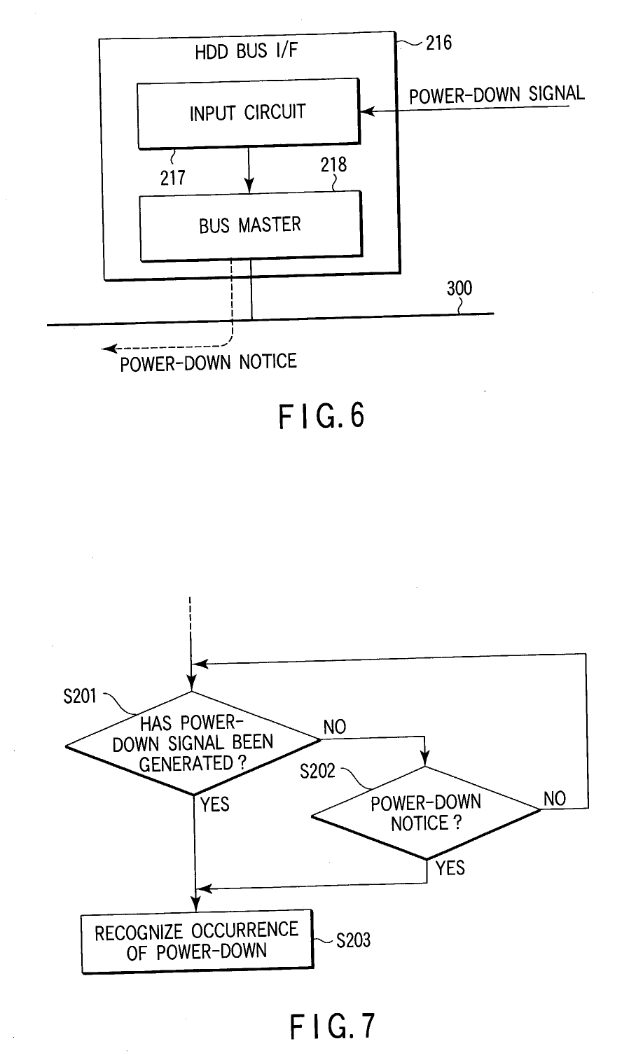

FIG. 6 shows an example of the structure of the HDD bus interface unit 216. The HDD bus interface unit 216, as shown in FIG. 6, comprises an input circuit 217 and a bus master 218.

The input circuit 217 is configured to receive the second power-down signal from the power supply unit 215. Upon receiving the second power-down signal with value “1”, the input circuit 217 notifies the bus master 218 of the reception of the second power-down signal. The bus master 218 is a bus master device that can issue a bus transaction on the disk access bus 300. Responding to the notice from the input circuit 217, the bus master 218 starts the bus transaction and notifies the RAID controller 113 of the generation of the second power-down signal (power-down notice).

A flow chart of FIG. 7 illustrates the operation of the RAID controller 114 in association with the structure of the extension HDD device 21 shown in FIG. 5.

The RAID controller 114 always monitors the first power-down signal from the power supply unit 115 and the power-down notice from the extension HDD device 21. To begin with, the RAID controller 114 determines whether the power supply unit 115 has generated the first power-down signal (step S201). Upon detecting the generation of the first power-down signal, the RAID controller 114 recognizes that power supply abnormality (power-down) has occurred in the information processing system and executes a data-integrity maintaining process (step S203). On the other hand, if the first power-down signal has not been generated, the RAID controller 114 determines the presence/absence of the power-down notice from the extension HDD device 21 (step S202). If the power-down notice has been generated from the extension HDD device 21, the RAID controller 114 recognizes that power supply abnormality (power-down) has occurred in the information processing system and executes the data-integrity maintaining process (step S203).

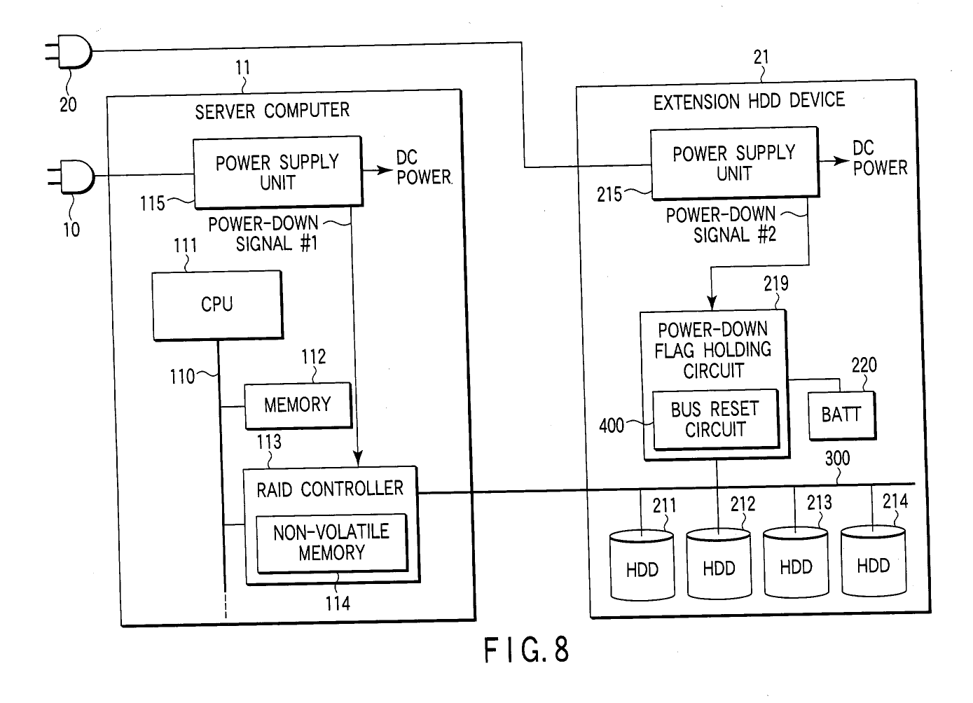

FIG. 8 shows an information processing system according to a second embodiment of the present invention. The information processing system of the second embodiment is configured such that the generation of the second power-down signal is not immediately told to the server computer 11 but the information indicative of the generation of the second power-down signal is retained as power-failure information in the extension HDD device 21. In other respects, the second embodiment is the same as the first embodiment.

Specifically, the extension HDD device 21 is provided with a power-down flag holding circuit 219. The power-down flag holding circuit 219 is backed up by a dedicated battery 220. The power-down flag holding circuit 219 is used to set a power-down flag, which is indicative of the generation of the second power-down signal from the power supply unit 215, in the extension HDD device 21 as power-failure information.

When a power failure has occurred in the extension HDD device 21 due to, e.g. disconnection, the RAID controller 113, once, erroneously recognizes that all the HDDs have failed, since no response is returned from any of the HDDs. After recovery from the power failure, however, the RAID controller 113 refers to the power-down flag set in the power-down flag holding circuit 219 and can actually recognize that the absence of a response from all HDDs is due to not a fault in the HDDs but a power failure. Thereby, the fault information stored in the non-volatile memory 114, which is indicative of the fault of all HDDs, is invalidated. Thus, after the recovery from the power failure, the RAID controller 113 can start the disk access.

In addition, the power-down flag holding circuit 219 is provided with a bus reset circuit 400. When the second power-down signal has been generated from the power supply unit 215, the bus reset circuit 400 resets the disk access bus 300 by setting the disk access bus 300 in a reset state or busy state. Thereby, before DC power supply from the power supply unit 215 is stopped, the RAID controller 113 is prohibited from executing the disk access. Even where power supply abnormality has occurred only in the extension HDD device 21, the disk access is prohibited prior to the stop of DC power supply from the power supply unit 215. Therefore, loss of unsaved write data, the write operation of which is in progress, can be prevented.

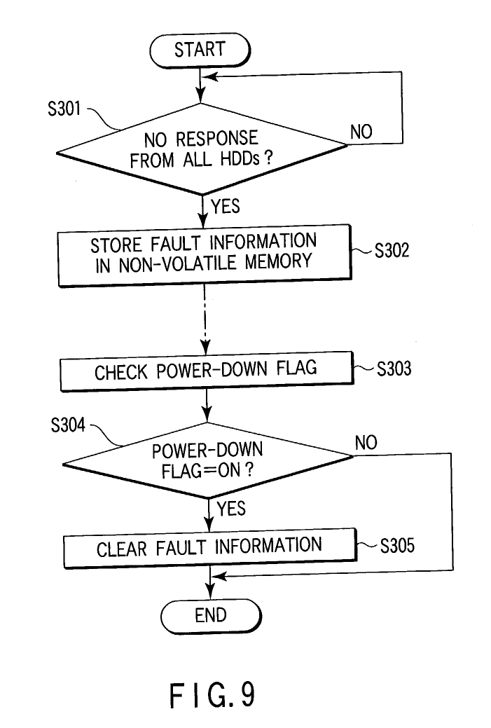

Referring to a flow chart of FIG. 9, the operation of the RAID controller 113 in the information processing system shown in FIG. 8 will be described. Assume that power supply abnormality due to a power failure has occurred only in the extension HDD device 21.

When power supply abnormality due to a power failure has occurred in the extension HDD device 21, the power supply unit 215 generates the second power-down signal. In response to the second power-down signal, the power-down flag “ON” is set in the power-down flag holding circuit 219 and the bus reset circuit 400 sets the disk access bus 300 in the reset state. Thereby, no response is returned from all HDDs 211 to 214 to the RAID controller 113 (YES in step S301), and the RAID controller 113 writes in the non-volatile memory 114 fault information indicating that all the HDDs 211 to 214 of the disk array have failed (step S302). Hereafter, the RAID controller 113 will no longer execute the disk access.

Then, if the extension HDD device 21 has recovered from the power failure, the RAID controller 113 first executes a read access to the power-down flag holding circuit 219 via the disk access bus 300 and checks the power-down flag (step S303). If the power-down flag=“ON” (YES in step S304), the RAID controller 113 recognizes that the absence of responses from all the HDDs 211 to 214 is due to a power failure, and RAID controller 113 clears the fault information written in the non-volatile memory 114 in step S302 (step S305). Hereafter, the RAID controller 113 normally executes access to the disk array.

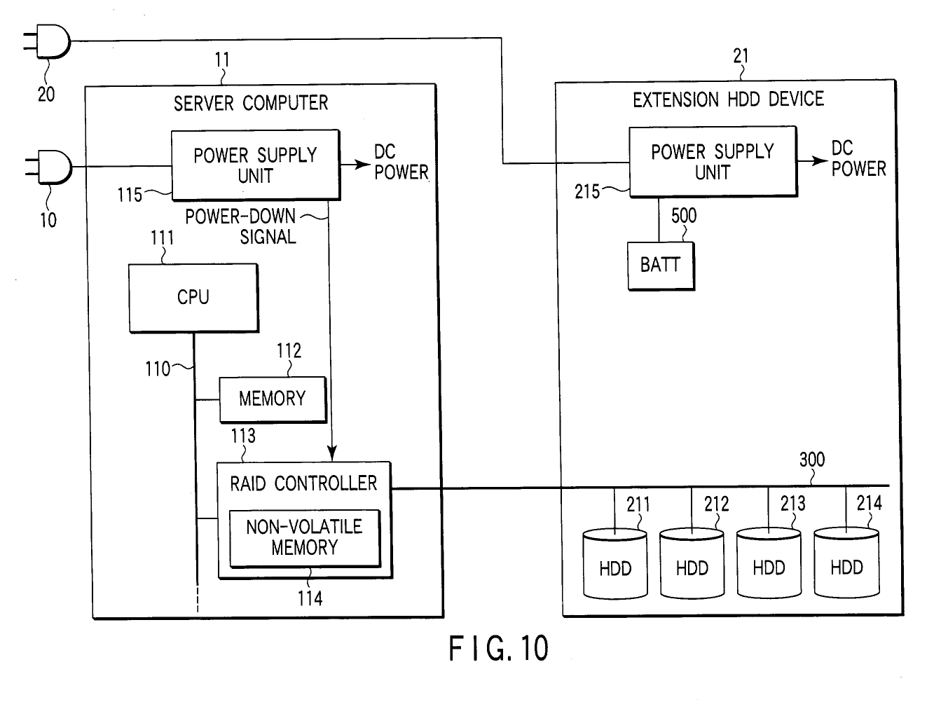

FIG. 10 shows an information processing system according to a third embodiment of the present invention. In the first embodiment, the power supply abnormality of the power supply unit 215 is told from the extension HDD device 21 to the server computer 11. In the third embodiment, the power supply abnormality is not told to the server computer 11. Instead, the power-failure tolerance of the power supply unit 215 of extension HDD device 21 is set to be higher than that of the power supply unit 115 of server computer 11. In the other respects, the third embodiment is the same as the first embodiment.

Specifically, the power supply unit 215 of extension HDD device 21 is provided with a large-capacity battery 500. This lowers such a possibility that DC power supply to the disk array may be stopped before the power supply unit 115 generates the first power-down signal. To be more specific, in a case where a power failure has occurred in each of the server computer 11 and extension HDD device 21, the RAID controller 113 can halt the disk access and execute a data-integrity maintaining process, while DC power is being supplied from the DC power supply to the disk array. It is therefore possible to prevent loss of unsaved write data, the write operation of which is in progress, or the erroneous recognition that all HDDs have failed.

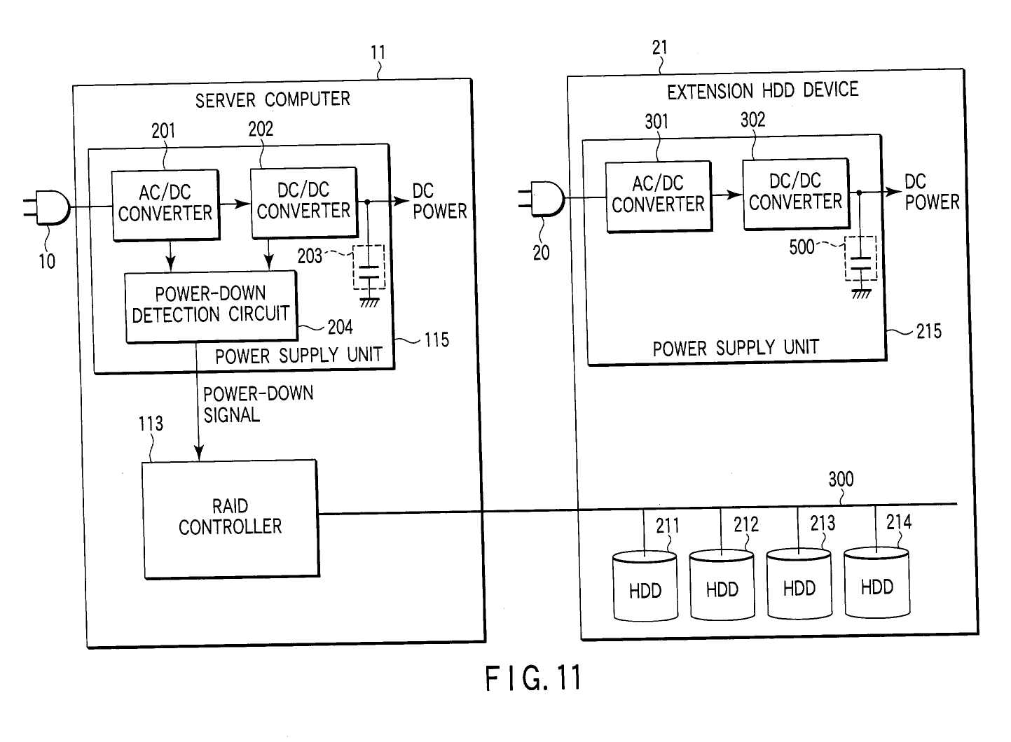

FIG. 11 shows an example of structures of the power supply units 115 and 215.

The power supply unit 115, like the first embodiment, comprises an AC/DC converter 201, a DC/DC converter 202, a battery 203 and a power-down detection circuit 204.

The power supply unit 215 comprises an AC/DC converter 201, a DC/DC converter 202, and a large-capacity battery 500. An electrical charge that can be accumulated in the large-capacity battery 500 is greater than that of the battery 203 of power supply unit 115. Thanks to this structure, DC power to the disk array is not stopped even when such an instantaneous power failure has occurred that the supply of power from the external AC power supply is instantaneously halted and then shortly recovered. Therefore, a necessary data-integrity maintaining process can be appropriately performed by monitoring the generation of only the first power-down signal from the power supply unit 115.

The structures of the above-described structures are applicable not only to the case where the server computer 11 controls the external disk array, but also to the case where the server computer 11 controls a single external disk storage device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing system including an information processing apparatus and a disk storage device, the system comprising:
a first power supply unit provided in the information processing apparatus;
a unit that is provided in the information processing apparatus and generates a first power-failure notice signal, which indicates that power supply from the first power supply unit is to be stopped, before the power supply from the first power supply unit is stopped;
a second power supply unit provided in the disk storage device;
a unit that is provided in the disk storage device and sends a second power-failure notice signal, which indicates that power supply from the second power supply unit is to be stopped, to the information processing apparatus before the power supply from the second power supply unit is stopped; and
a disk control unit that is provided in the information processing apparatus and controls the disk storage device, the disk control unit including a unit which halts access to the disk storage device upon receiving one of the first and second power-failure notice signals.

2. The information processing system according to claim 1, wherein the disk storage device includes a plurality of disk drive units that constitute a disk array.

3. The information processing system according to claim 1, wherein a signal line is provided between the information processing apparatus and the disk storage device, and
the unit that sends the second power-failure notice signal includes a unit that sends the second power-failure notice signal to the information processing apparatus via the signal line.

4. The information processing system according to claim 1, wherein a disk access bus, which is used by the disk control unit to access the disk storage device, is provided between the information processing apparatus and the disk storage device, and
the unit that sends the second power-failure notice signal includes a unit that sends the second power-failure notice signal to the information processing apparatus via the disk access bus.

5. The information processing system according to claim 4, wherein the unit that sends the second power-failure notice signal to the information processing apparatus via the disk access bus includes a unit which executes a bus transaction for transmitting data indicative of the generation of the second power-failure notice signal to the information processing apparatus via the disk access bus.

6. The information processing system according to claim 1, wherein the disk storage device includes a plurality of disk drive units that constitute a disk array, and
the disk control unit includes:
means for accessing each of the plurality of the disk drive units; and
means for detecting a failed disk drive unit on the basis of the presence/absence of a response from each accessed disk drive unit.

7. The information processing system according to claim 1, wherein the first power supply unit includes:
an AC/DC converter which converts an externally input AC power supply to a DC power supply;
a DC/DC converter which generates a specific operational power supply voltage from the DC power supply produced by the AC/DC converter; and
a unit which maintains an output of the operational power supply voltage for a predetermined time period from occurrence of a power failure of the AC power supply, and
wherein the unit that generates the first power-failure notice signal includes a unit which generates the first power-failure notice signal in response to the occurrence of the power failure of the AC power supply.

8. The information processing system according to claim 1, wherein the second power supply unit includes:
an AC/DC converter which converts an externally input AC power supply to a DC power supply;
a DC/DC converter which generates a specific operational power supply voltage from the DC power supply produced by the AC/DC converter; and
a unit which maintains an output of the operational power supply voltage for a predetermined time period from occurrence of a power failure of the AC power supply, and
wherein the unit that generates the second power-failure notice signal includes a unit which generates the second power-failure notice signal in response to the occurrence of the power failure of the AC power supply.

9. A method of controlling a disk storage device by an information processing apparatus, the disk storage device and the information processing apparatus having a first power supply unit and a second power supply unit, the method comprising:
generating a first power-failure notice signal, which indicates that power supply from the first power supply unit is to be stopped, before the power supply from the first power supply unit is stopped;
sending from the disk storage device a second power-failure notice signal, which indicates that power supply from the second power supply unit is to be stopped, to the information processing apparatus before the power supply from the second power supply unit is stopped; and
halting access to the disk storage device upon receiving one of the first and second power-failure notice signals from the information processing apparatus.

10. The method according to claim 9, wherein the disk storage device includes a plurality of disk drive units that constitute a disk array.

11. The method according to claim 9, wherein a signal line is provided between the information processing apparatus and the disk storage device, and
the sending of the second power-failure notice signal includes sending the second power-failure notice signal to the information processing apparatus via the signal line.

12. The method according to claim 9, wherein a disk access bus, which is used by the information processing apparatus to access the disk storage device, is provided between the information processing apparatus and the disk storage device, and
the sending of the second power-failure notice signal includes sending the second power-failure notice signal to the information processing apparatus via the disk access bus.

13. The method according to claim 12, wherein the sending of the second power-failure notice signal to the information processing apparatus via the disk access bus includes executing a bus transaction for transmitting data indicative of the generation of the second power-failure notice signal to the information processing apparatus via the disk access bus.

14. An information processing system including an information processing apparatus and a disk storage device, the system comprising:
a first power supply unit provided in the information processing apparatus;
a unit that is provided in the information processing apparatus and generates a power-failure notice signal, which indicates that power supply from the first power supply unit is to be stopped, before the power supply from the first power supply unit is stopped;
a second power supply unit provided in the disk storage device;
a unit that is provided in the disk storage device and stores power-failure information indicative of whether power supply from the second power supply unit is stopped; and
a disk control unit provided in the information processing apparatus and controlling the disk storage device, the disk control unit including means for accessing the disk storage device, means for halting access to the disk storage device upon receiving the power-failure notice signal, means for detecting whether a fault has occurred in the disk storage device or not, on the basis of presence/absence of a response to the access from the disk storage device, and means for invalidating a detection result indicative of the occurrence of the fault in the disk storage device when the power-failure information is indicative of the stop of the power supply from the second power supply unit.

15. The information processing system according to claim 14, wherein the disk storage device includes a plurality of disk drive units that constitute a disk array.

16. The information processing system according to claim 14, wherein the first power supply unit includes:
an AC/DC converter which converts an externally input AC power supply to a DC power supply;
a DC/DC converter which generates a specific operational power supply voltage from the DC power supply produced by the AC/DC converter; and
a unit which maintains an output of the operational power supply voltage for a predetermined time period from occurrence of a power failure of the AC power supply, and
wherein the unit that generates the power-failure notice signal includes a unit which generates the power-failure notice signal in response to the occurrence of the power failure of the AC power supply.

17. An information processing system including an information processing apparatus and a disk storage device, the system comprising:
a first power supply unit provided in the information processing apparatus and configured to maintain power supply for a predetermined time period from occurrence of a power failure;
a unit that is provided in the information processing apparatus and generates a power-failure notice signal, which indicates that power supply from the first power supply unit is to be stopped, before the power supply from the first power supply unit is stopped;
a second power supply unit provided in the disk storage device and configured to maintain power supply for a longer time period than the first power supply unit from occurrence of a power failure; and
a disk control unit that is provided in the information processing apparatus and controls the disk storage device, the disk control unit including a unit which halts access to the disk storage device upon receiving the power-failure notice signal.

18. The information processing system according to claim 17, wherein the disk storage device includes a plurality of disk drive units that constitute a disk array.

19. The information processing system according to claim 17, wherein the disk storage device includes a plurality of disk drive units that constitute a disk array, and
the disk control unit includes:
means for accessing each of the plurality of the disk drive units; and
means for detecting a failed disk drive unit on the basis of the presence/absence of a response from each accessed disk drive unit.
